(19) United States
(12) Patent Application Publication
(10) Pub. No.: US 2025/0139296 A1
(43) Pub. Date: May 1, 2025

(54) DATA STORAGE APPARATUS, DATA STORAGE METHOD, AND PROGRAM

(71) Applicant: NEC Corporation, Minato-ku, Tokyo (JP)

(72) Inventors: Isamu FURUYA, Tokyo (JP); Akiko MUKAI, Tokyo (JP); Kazuhiko MINEMATSU, Tokyo (JP)

(73) Assignee: NEC Corporation, Minato-ku, Tokyo (JP)

(21) Appl. No.: 18/837,269

(22) PCT Filed: Feb. 25, 2022
(86) PCT No.: PCT/JP2022/007929

§ 371 Date: Aug. 9, 2024

(51) Int. Cl. G06F 21/64; G06F 21/55

(52) U.S. Cl. CPC G06F 21/64; G06F 21/554

(57) ABSTRACT

A data storage apparatus, including: encoding part; and falsification correction part; wherein the encoding part includes code generation section that generates, based on original data and falsification frequency, a code which enables correction of the original data, and includes a tag generation section that generates a first tag which enables detection of falsification of the original data, based on the original data; wherein the encoding part stores the code and the first tag in a storage part; and wherein the falsification correction part includes a falsified portion determination section that retrieves a falsified code and the first tag from the storage part, generates a second tag based on the falsified code, and determines a falsified portion(s) in the falsified code by using the first tag and the second tag, and includes a data correction section that outputs corrected original data by using the determined falsified portion(s) and the falsified code.

This application is a National Stage Entry of PCT/JP2022/007929 filed on Feb. 25, 2022, the contents of all of which are incorporated herein by reference, in their entirety.

### FIELD

The present invention relates to a data storage apparatus, a data storage method, and a program.

### BACKGROUND

Various methods for detecting and correcting data falsification have been proposed.

Patent Literature (PTL) 1 relates to a non-volatile storage system that detects occurrence of errors even if errors exceeding the error correction capability occur.

PTL 2 relates to an information processing apparatus that determines whether a message received by the information processing apparatus relates to a malicious attack. PTL 3 relates to a transmission apparatus that transmits encrypted data obtained by encrypting transmission data based on a keystream generated based on GPS time information.

PTL 4 discloses a MAC tag list generation apparatus, a MAC tag list generation method, a MAC tag list verification apparatus, and a MAC tag list verification method for executing group-test-based message authentication coding using exclusive OR and for executing verification.
PTL 1: Japanese Patent Kokai Publication No. 2014-191372
PTL 2: Japanese Patent Kokai Publication No. 2016-096419
PTL 3: Japanese Patent Sai-Koho Publication WO 2020/059535
PTL 4: WO 2020/213114

### SUMMARY

The following analysis has been made by the present invention.

There is a demand for determining whether stored data has been falsified. If falsification of stored data is detected, there is a demand for correcting the data.

To meet these demands, as one method for correcting falsification (error) of data, there is a method in which data is encoded by an error correction code (ECC). If data is encoded by an error correction code, falsification (error) of data can be detected and corrected. However, in an error correction code that executes decoding based on a bounded distance decoding method, if data is made up of n items, at least “+2d” items of check symbols need to be added for a maximum falsification frequency d, and therefore, the increase amount of data becomes large. However, if the number of falsified portions exceeds d, there is no guarantee that the data can be corrected, and detection of falsification is also impossible.

Meanwhile, as a method for detecting falsification of data, there is a method for generating message authentication code (MAC) tags from data. While these MAC tags cannot enable correction of falsified data, the MAC tags enable detection of falsification of data. The data may be stored in a large-capacity off-chip area, which may not be secure.

In contrast, the MAC tags need a write-protected secure area in which falsification is not possible, that is, an on-chip area. However, the increase of the tag portions with respect to the data is small, which is “+fixed length bit”. In addition, no matter how many data stored in the large-capacity off-chip area have been falsified, detection of falsification is possible based on the tags.

It is an object of the present invention to provide a data storage apparatus, a data storage method, and a program that contribute to enabling detection and correction of falsification of stored data and enabling detection of falsification no matter how many stored data have been falsified while keeping the increase amount of the stored data to a minimum.

According to a first aspect of the present invention, there is provided a data storage apparatus, including:
an encoding part; and
a falsification correction part;
wherein the encoding part includes a code generation section that generates, based on original data and a falsification frequency, a code which enables correction of the original data, and includes a tag generation section that generates a first tag which enables detection of falsification of the original data, based on the original data;
wherein the encoding part stores the code and the first tag in a storage part; and
wherein the falsification correction part includes a falsified portion determination section that retrieves a falsified code and the first tag from the storage part, generates a second tag based on the falsified code, and determines a falsified portion(s) in the falsified code by using the first tag and the second tag, and includes a data correction section that outputs corrected original data by using the determined falsified portion(s) and the falsified code.

According to a second aspect of the present invention, there is provided a data storage method, executed by a computer and including:
generating, based on original data and a falsification frequency, a code which enables correction of the original data;
generating a first tag which enables detection of falsification of the original data, based on the original data;
storing the code and the first tag in a storage part;
retrieving a falsified code and the first tag from the storage part;
generating a second tag based on the falsified code and determining a falsified portion(s) in the falsified code by using the first tag and the second tag; and
outputting corrected original data by using the determined falsified portion(s) and the falsified code.

According to a third aspect of the present invention, there is provided a program, causing a computer to execute:
a code generation processing for generating, based on original data and a falsification frequency, a code which enables correction of the original data;
a tag generation processing for generating a first tag which enables detection of falsification of the original data, based on the original data;
a processing for storing the code and the first tag in a storage part;
a processing for retrieving a falsified code and the first tag from the storage part;
a falsified portion determination processing for generating a second tag based on the falsified code and determining a falsified portion(s) in the falsified code by using the first tag and the second tag; and
a data correction processing for outputting corrected original data by using the determined falsified portion(s) and the falsified code.
   Note, this program can be recorded in a computer-readable storage medium. The storage medium may be a non-transitory storage medium such as a semiconductor memory, a hard disk, a magnetic recording medium, or an optical recording medium. The present invention can be embodied as a computer program product.

The present invention can provide a data storage apparatus, a data storage method, and a program that contribute to enabling detection and correction of falsification of stored data and enabling detection of falsification no matter how many stored data have been falsified while keeping the increase amount of the stored data to a minimum.

### BRIEF DESCRIPTION OF DRAWINGS

FIG. 1 is a diagram illustrating an example of a schematic configuration of a data storage apparatus according to an example embodiment of the present invention.

FIG. 2 is a diagram illustrating an example of a schematic configuration of original data M inputted to the data storage apparatus according to the example embodiment of the present invention.

FIG. 3 is a diagram illustrating an example of a schematic configuration of a data storage apparatus according to a first example embodiment of the present invention.

FIG. 4 is a diagram illustrating an example of a schematic operation of a data duplication section in an encoding part in the data storage apparatus according to the first example embodiment of the present invention.

FIG. 5 is a diagram illustrating an example of a schematic operation of a MAC tag generation section in the encoding part in the data storage apparatus according to the first example embodiment of the present invention.

FIG. 6 is a diagram illustrating an example of a schematic operation of a falsified portion determination section in a falsification correction part in the data storage apparatus according to the first example embodiment of the present invention.

FIG. 7 is a diagram illustrating an example of a schematic operation of a data selection section in the falsification correction part in the data storage apparatus according to the first example embodiment of the present invention.

FIG. 8 is a diagram illustrating an example of a schematic configuration of a data storage apparatus according to a second example embodiment of the present invention.

FIG. 9 is a diagram illustrating an example of a schematic operation of an erasure correction encoding section in an encoding part in the data storage apparatus according to the second example embodiment of the present invention.

FIG. 10 is a diagram illustrating an example of a schematic operation of a CDMAC tag generation section in the encoding part in the data storage apparatus according to the second example embodiment of the present invention.

FIG. 11 is a diagram illustrating an example of a schematic operation of a falsified portion determination section in a falsification correction part in the data storage apparatus according to the second example embodiment of the present invention.

FIG. 12 is a diagram illustrating an example of a schematic operation of an erasure correction section in the falsification correction part in the data storage apparatus according to the second example embodiment of the present invention.

FIG. 13 is a diagram illustrating an example of a schematic configuration of a data storage apparatus according to a third example embodiment of the present invention.

FIG. 14 is a diagram illustrating an example of a schematic operation of a tag generation section using a collision-resistant hash function included in an encoding part in the data storage apparatus according to the third example embodiment of the present invention.

FIG. 15 is a diagram illustrating an example of a schematic operation of a falsified portion determination section in a falsification correction part in the data storage apparatus according to the third example embodiment of the present invention.

FIG. 16 is a diagram illustrating an example of a schematic configuration of a data storage apparatus according to a fourth example embodiment of the present invention.

FIG. 17 is a diagram illustrating an example of a schematic operation of a tag generation section using XOR-GTM, the tag generation section included in an encoding part in the data storage apparatus according to the fourth example embodiment of the present invention.

FIG. 18 is a diagram illustrating an example of a schematic operation of a falsified portion determination section in a falsification correction part in the data storage apparatus according to the fourth example embodiment of the present invention.

FIG. 19 is a diagram illustrating an example of comparison of schematic parameters between the data storage apparatuses according to the first and second example embodiments of the present invention.

FIG. 20 is a diagram illustrating a configuration of a computer making up a data storage apparatus according to the present invention.

### DESCRIPTION OF EMBODIMENTS

First, an outline of an exemplary embodiment of the present invention will be described with reference to drawings. In the following outline, reference signs of the drawings are denoted to each element as an example for the sake of convenience to facilitate understanding and is not intended to limit the present invention to the illustrated modes. An individual connection line between blocks in an individual drawing, etc. referred to hereinafter includes both one-way and two-way directions. A one-way arrow schematically illustrates a principal signal (data) flow and does not exclude bidirectionality.

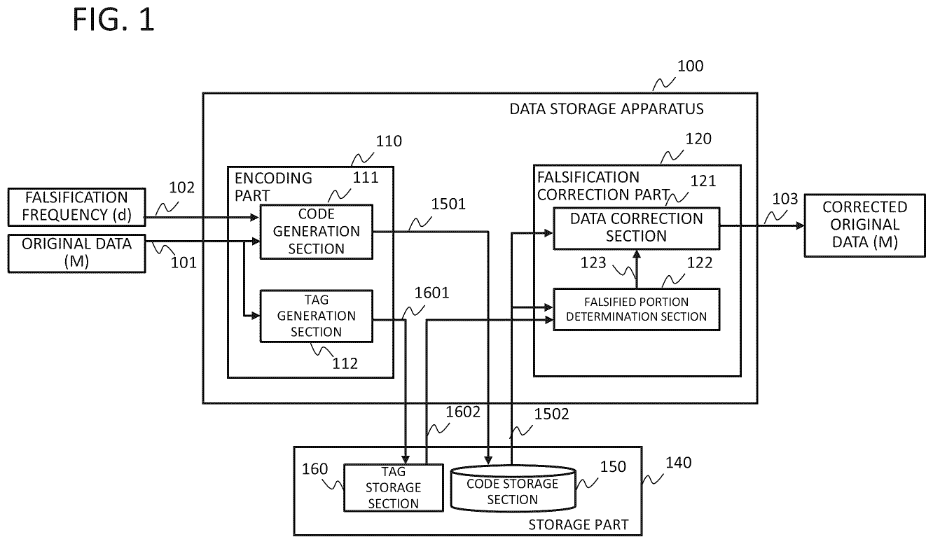

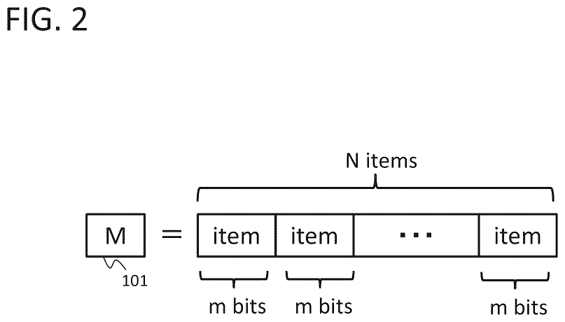

FIG. 1 is a diagram illustrating an example of a schematic configuration of a data storage apparatus 100 according to an example embodiment of the present invention. As illustrated in FIG. 1, the data storage apparatus 100 includes an encoding part 110 and a falsification correction part 120. FIG. 2 is a diagram illustrating an example of a schematic configuration of original data M inputted to the data storage apparatus according to the example embodiment of the present invention. As illustrated in FIG. 2, it is assumed that the original data (M) 101 is made up by N items, each of which is represented by m bits. In addition, it is assumed that a falsification frequency (d) 102 indicates a maximum number of portions that could be falsified in the original data.

The encoding part 110 includes a code generation section 111 that generates, based on the original data (M) 101 and the falsification frequency (d) 102, a code 1501 which enables correction of the original data 101, and includes a tag generation section 112 that generates a first tag 1601 which enables detection of falsification of the original data, based on the original data (M) 101. The encoding part 110 stores the code 1501 and the first tag 1601 in a storage part 140. The storage part 140 includes a code storage section 150 and a tag storage section 160. The code 1501 is stored in the code storage section 150, and the first tag 1601 is stored in the tag storage section 160, respectively. For example, the code storage section 150 is a large-capacity off-chip storage section, which may not be secure, and the tag storage section 160 is a secure on-chip storage section, which may not have a large capacity. The following description assumes that the code 1501 stored in the code storage section 150, which may not be secure, could be falsified and that a retrieved code 1502 has been falsified.

The falsification correction part 120 retrieves the falsified code 1502 from the code storage section 150 in the storage part 140, and retrieves a first tag 1602 from the tag storage section 160 in the storage part 140. Since the retrieved first tag 1602 has been stored in the tag storage section 160, which is a secure on-chip storage section, the retrieved first tag 1602 is the same as the stored first tag 1601 and has not been falsified.

The falsification correction part 120 includes a falsified portion determination section 122 and a data correction section 121. The falsified portion determination section 122 generates a second tag based on the falsified code 1502, and determines a falsified portion(s) 123 in the falsified code 1502 by using the first tag 1602 and the second tag. The data correction section 121 outputs corrected original data (M) 103 by using the determined falsified portion(s) 123 and the falsified code 1502.

As described above, according to the data storage apparatus 100 according to the example embodiment of the present invention, it is possible to provide a data storage apparatus 100 that contributes to enabling detection and correction of falsification of stored data and enabling detection of falsification no matter how many stored data have been falsified while keeping the increase amount of the stored data to a minimum, compared with a case in which the original data (M) 101 is encoded by an error correction code (ECC), an error location(s) and an error value(s) of the falsified code 1502 are calculated, and error correction is executed.

### First Example Embodiment

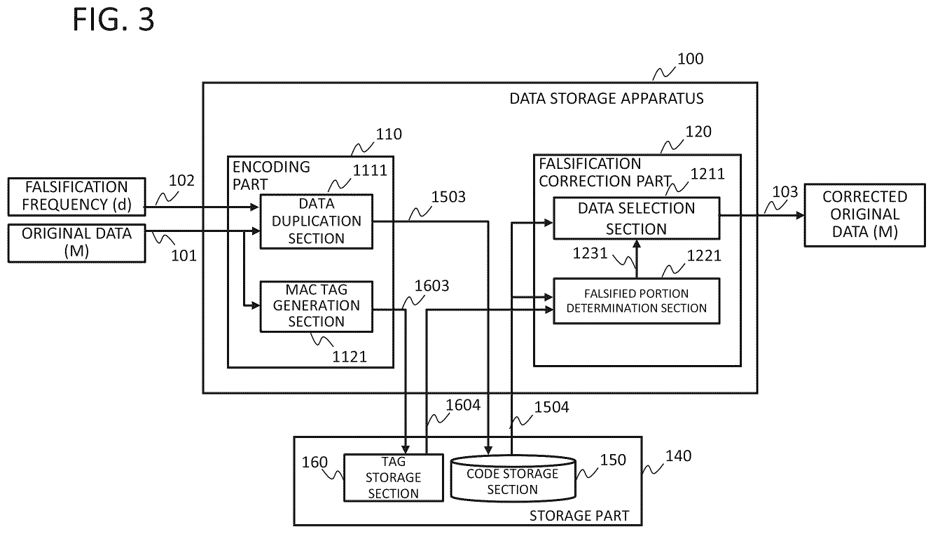

Next, an example of a configuration of a data storage apparatus 100 according to a first example embodiment of the present invention will be described with reference to drawings. FIG. 3 is a diagram illustrating an example of a schematic configuration of the data storage apparatus according to the first example embodiment of the present invention. An operation executed by the data storage apparatus 100 according to the first example embodiment of the present invention will be referred to CCMAC (Corruption Correctable Message Authentication Code)-Naive (i is a letter obtained by adding a diaeresis to I).

In FIG. 3, the same components as those described in FIG. 1 are denoted by the same reference numerals, and the description thereof will be omitted. FIG. 2 is a diagram illustrating an example of a schematic configuration of original data M inputted to the data storage apparatus 100 according to the first example embodiment of the present invention.

As illustrated in FIG. 2, it is assumed that the original data (M) 101 is made up by N items, each of is represented by m bits. In addition, it is assumed that a falsification frequency (d) 102 indicates a maximum number of portions that could be falsified in the original data. The same applies to second to fourth example embodiments, which will be described below.

As illustrated in FIG. 3, an encoding part 110 in the data storage apparatus 100 according to the first example embodiment of the present invention includes a data duplication section 1111 and a MAC tag generation section 1121, which correspond to the code generation section 111 and the tag generation section 112 illustrated in FIG. 1, respectively. A falsification correction part 120 includes a data selection section 1211 and a falsified portion determination section 1221, which correspond to the data correction section 121 and the falsified portion determination section 122 illustrated in FIG. 1, respectively.

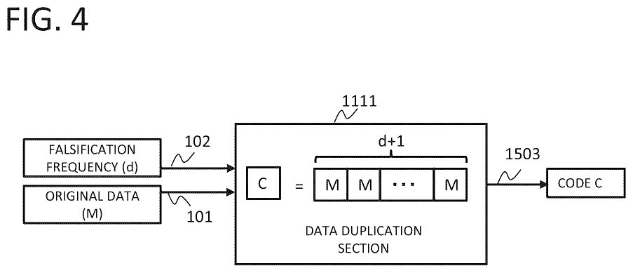

FIG. 4 is a diagram illustrating an example of a schematic operation of the data duplication section 1111 in the encoding part 110 in the data storage apparatus 100 according to the first example embodiment of the present invention. The data duplication section 1111 receives the original data (M) 101 and the falsification frequency (d) 102 and outputs a code C 1503 by duplicating the original data (M) 101 d+1 times, which is greater than a maximum number d of portions that could be falsified in the original data by 1. The outputted code C 1503 is stored in a code storage section 150 in a storage part 140.

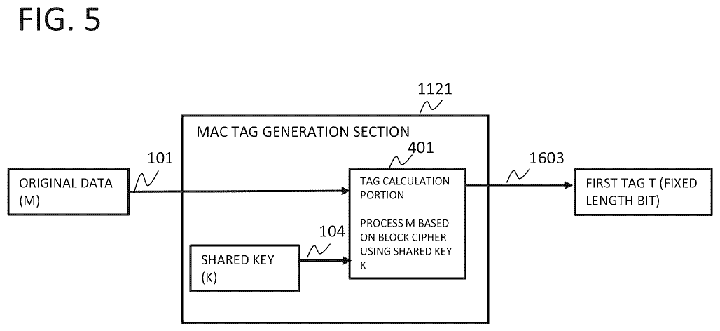

FIG. 5 is a diagram illustrating an example of a schematic operation of the MAC tag generation section 1121 in the encoding part 110 in the data storage apparatus 100 according to the first example embodiment of the present invention. A tag calculation portion 401 in the MAC tag generation section 1121 receives the original data (M) 101, processes (encrypts) the original data (M) 101 based on a block cipher using a supplied shared key (K) 104, and outputs a first tag T 1603 for the entire original data (M) 101. The outputted first tag T 1603 is stored in a tag storage section 160.

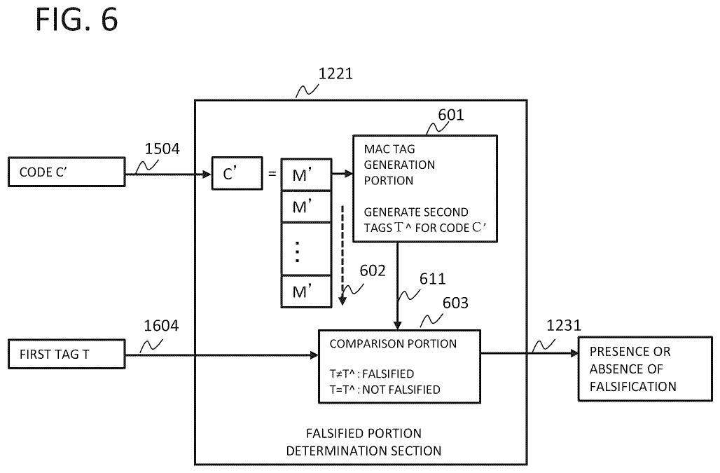

FIG. 6 is a diagram illustrating an example of a schematic operation of the falsified portion determination section 1221 in the falsification correction part 120 in the data storage apparatus 100 according to the first example embodiment of the present invention.

The code storage section 150 in the storage part 140 illustrated in FIG. 3 is a large-capacity off-chip storage section, which may not be secure. The following description assumes that the code stored in the code storage section 150 has been falsified and that a falsified code C′ 1504 is stored in the code storage section 150. In contrast, the tag storage section 160 in the storage part 140 is a secure on-chip storage section, which may not have a large capacity. The following description assumes that the first tag T 1603 stored in the tag storage section 160 has not been falsified. The falsification correction part 120 retrieves the falsified code C′ 1504 from the code storage section 150, and retrieves a first tag T 1604 from the tag storage section 160. The retrieved first tag T 1604 is the same as the stored first tag T 1603.

As illustrated in FIG. 6, the retrieved falsified code C′ 1504 includes data M′, which corresponds to the original data M (101) duplicated d+1 times and which could have been falsified. With respect to each of the data M′, which is included in the falsified code C′ 1504 and which could have been falsified, by using the same method executed by the MAC tag generation section 1121 in FIG. 5, a MAC tag generation portion 601 processes (encrypts) each of the data M′ which could have been falsified, based on a block cipher using the supplied shared key (K) 104, and sequentially generates second tags T\hat{ } 611 as indicated by an arrow 602. Next, a comparison portion 603 compares the retrieved first tag T 1604 with the second tags T\hat{ } 611. If a second tag T\hat{ } 611 matches the retrieved first tag T 1604, the comparison portion 603 determines that this data M′ has not been falsified. If a second tag T\hat{ } 611 differs from the retrieved first tag T 1604, the comparison portion 603 determines that this data M′ has been falsified. The comparison portion 603 outputs presence or absence of falsification 1231.

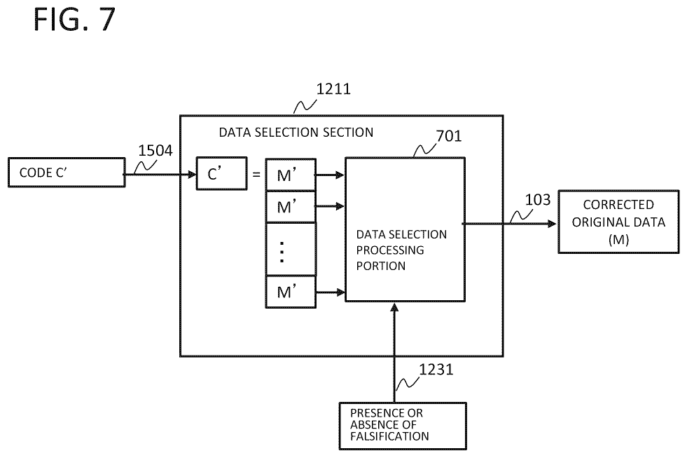

FIG. 7 is a diagram illustrating an example of a schematic operation of the data selection section 1211 in the falsification correction part 120 in the data storage apparatus 100 according to the first example embodiment of the present invention. The data selection section 1211 receives the retrieved falsified code C′ 1504 and the presence or absence of falsification 1231 outputted by the falsified portion determination section 1221. With respect to the data M′ in the falsified code C′ 1504, according to a corresponding presence or absence of falsification 1231, the data selection processing portion 701 does not select the corresponding data M′ when the falsification is present, and selects and outputs the corresponding data M′ as corrected original data (M) 103 when the absence of the falsification is inputted.

When the falsified portions exceed the falsification frequency (d) 102, e.g., when all the data M′ in the retrieved falsified code C′ 1504 has been falsified, the falsified portion determination section 1221 can detect the falsification of the stored data. However, when the data selection section 1211 cannot select any corrected original data (M) 103, the falsification of the stored data cannot be corrected.

As described above, according to the data storage apparatus 100 according to the first example embodiment of the present invention, it is possible to provide a data storage apparatus that contributes to enabling detection and correction of falsification of stored data and enabling detection of falsification no matter how many stored data have been falsified while keeping the increase amount of the stored data to a minimum, compared with a case in which the original data is encoded by an error correction code (ECC), an error location(s) and an error value(s) are calculated, and error correction is executed.

### Second Example Embodiment

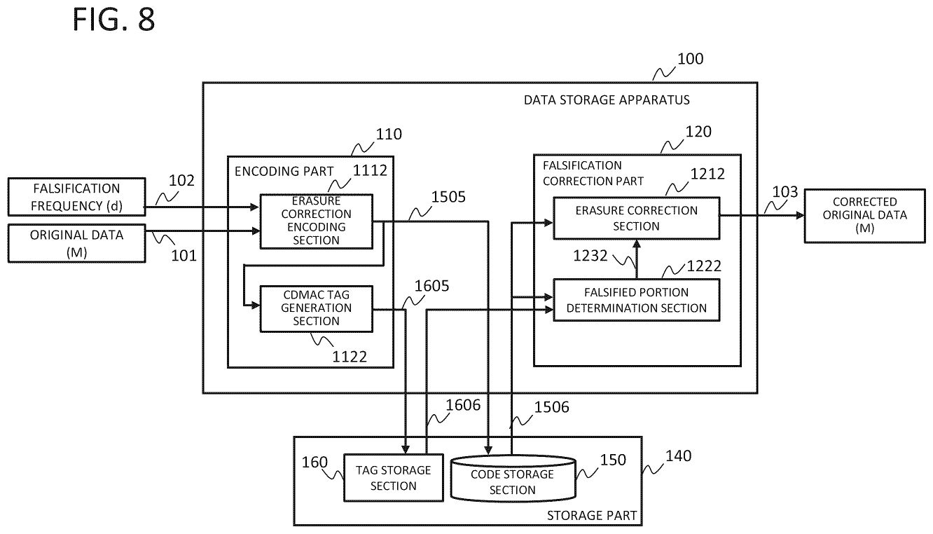

Next, a second example embodiment of the present invention will be described with reference to drawings. FIG. 8 is a diagram illustrating an example of a schematic configuration of a data storage apparatus 100 according to the second example embodiment of the present invention. An operation executed by the data storage apparatus 100 according to the second example embodiment of the present invention will be referred to as CCMAC-EC (Erasure Correction).

In FIG. 8, the same components as those in FIG. 1 are denoted by the same reference numerals, and the description thereof will be omitted.

As illustrated in FIG. 8, an encoding part 110 in the data storage apparatus 100 according to the second example embodiment of the present invention includes an erasure correction encoding section 1112 and a CDMAC (Corruption Detectable Message Authentication Code) tag generation section 1122, which correspond to the code generation section 111 and the tag generation section 112 illustrated in FIG. 1, respectively. A falsification correction part 120 includes an erasure correction section 1212 and a falsified portion determination section 1222, which correspond to the data correction section 121 and the falsified portion determination section 122 illustrated in FIG. 1, respectively.

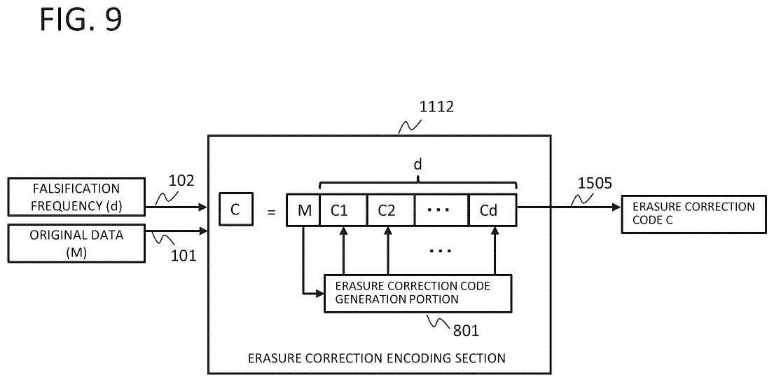

FIG. 9 is a diagram illustrating an example of a schematic operation of the erasure correction encoding section 1112 in the encoding part 110 in the data storage apparatus 100 according to the second example embodiment of the present invention. The erasure correction encoding section 1112 receives original data (M) 101 and a falsification frequency (d) 102, generates d check codes C1 to Cd that enable erasure correction of d falsifications or less for the original data (M) 101, and outputs an erasure correction code C 1505 including the original data (M) 101 and the d check codes C1 to Cd. The erasure correction code C 1505 is stored in a code storage section 150 in a storage part 140.

For example, the encoding of the check codes of the erasure correction code can be executed by using Reed-Solomon codes. Herein, it is assumed that the erasure correction is a correction method in which, when erasure of an item(s) whose error value(s) is unknown in an error correction code occurs, if only the location(s) where the erasure has occurred is obtained by some method, the original data is calculated based on information about the portions at which erasure has not occurred. Regarding the d falsifications (errors), when an error location(s) and an error value(s) are calculated and error correction is executed with only the Reed-Solomon codes without detecting the error (erasure) location(s) based on another method, it is necessary to generate 2d check codes and generate Reed-Solomon codes including the original data (M) 101 and the 2d check codes.

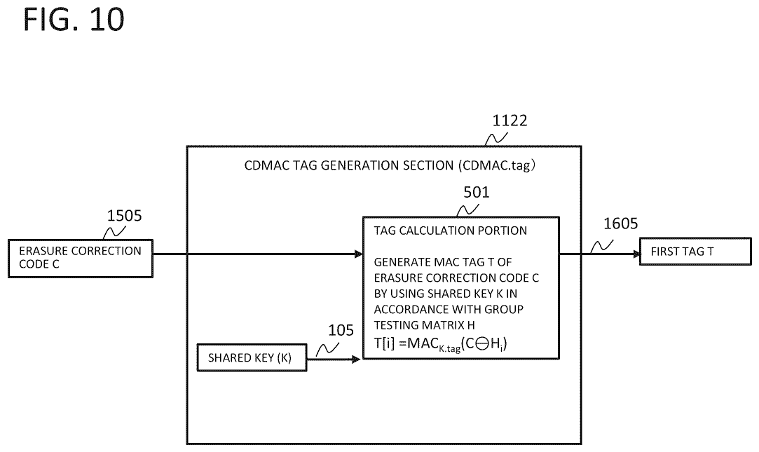

FIG. 10 is a diagram illustrating an example of a schematic operation of the CDMAC tag generation section 1122 in the encoding part 110 in the data storage apparatus 100 according to the second example embodiment of the present invention. A tag calculation portion 501 in the CDMAC tag generation section 1122 generates a MAC tag T of the erasure correction code C by using a shared key K in accordance with a group testing matrix H.

For example, as an example of the MAC tag T generation method, the tag calculation portion 501 extracts items corresponding to locations where 1 is set in an i-th low in a combinatorial group testing (CGT) matrix H from the erasure correction code C 1505, concatenates the items, and calculates a message authentication code (MAC) tag T[i] by using a shared key K 105 for each concatenated sequence. The tag calculation portion 501 executes this procedure for each row in the combinatorial group testing matrix H and generates a first tag T 1605, which is a list of tags T[i]. The first tag T 1605 is stored in a tag storage section 160 in the storage part 140.

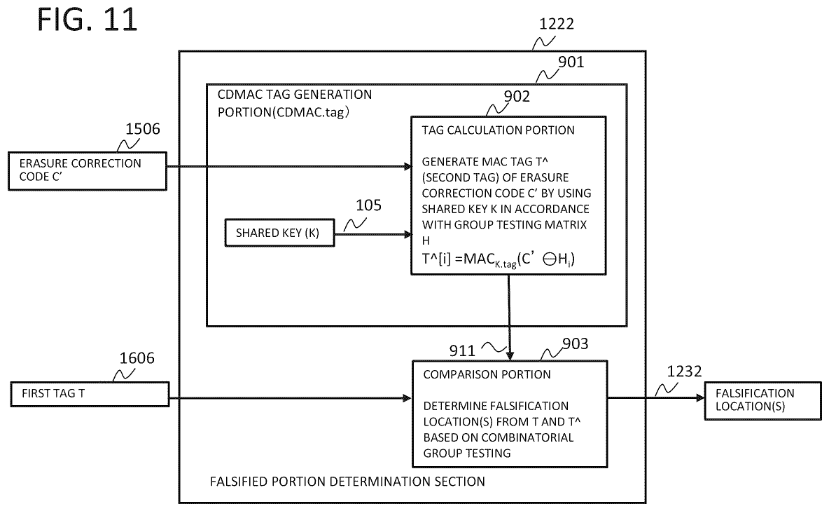

FIG. 11 is a diagram illustrating an example of a schematic operation of the falsified portion determination section 1222 in the falsification correction part 120 in the data storage apparatus 100 according to the second example embodiment of the present invention.

The code storage section 150 in the storage part 140 illustrated in FIG. 8 is a large-capacity off-chip storage section, which may not be secure. The following description assumes that the code stored in the code storage section 150 has been falsified and that a falsified erasure correction code C′ 1506 is stored in the code storage section 150. In contrast, the tag storage section 160 in the storage part 140 is a secure on-chip storage section, which may not have a large capacity. The following description assumes that the first tag T 1605 stored in the tag storage section 160 has not been falsified. The falsification correction part 120 retrieves the falsified erasure correction code C′ 1506 from the code storage section 150, and retrieves a first tag T 1606 from the tag storage section 160. The retrieved first tag T 1606 is the same as the stored first tag T 1605.

As illustrated in FIG. 11, a CDMAC tag generation portion 901 generates a second tag T\hat{ } 911 from the retrieved falsified erasure correction code C′ 1506 by using the same method executed by the CDMAC tag generation section 1122 in FIG. 10.

That is, a tag calculation portion 902 in the CDMAC tag generation section 901 extracts items corresponding to locations where 1 is set in an i-th row in a combinatorial group testing (CGT) matrix H from the falsified erasure correction code C′ 1506, concatenates the items, and calculates a message authentication code (MAC) tag T\hat{ }[i] by using the shared key K 105 for each concatenated sequence. The tag calculation portion 902 executes this procedure for each row in the combinatorial group testing matrix H and generates the second tag T\hat{ } 911, which is a list of tags T\hat{ }[i].

Next, a comparison portion 903 compares the first tag T 1606, which is a list of retrieved tags T[i], with the second tag T\hat{ }911, which is a list of tags T\hat{ }[i], determines a falsification location(s) in the falsified erasure correction code C′ 1506 based on combinatorial group testing, and outputs a falsification location(s) 1232.

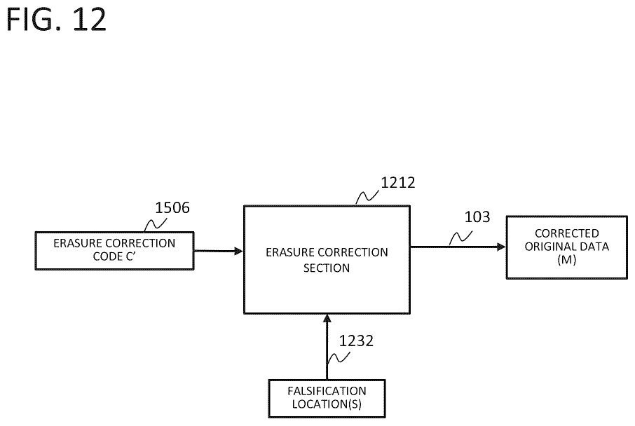

FIG. 12 is a diagram illustrating an example of a schematic operation of the erasure correction section 1212 in the falsification correction part 120 in the data storage apparatus 100 according to the second example embodiment of the present invention. By executing erasure correction on the d falsified portions or less by using the falsification location(s) 1232 in the falsified erasure correction code C′ 1506, the erasure correction section 1212 can correct falsification of the falsified erasure correction code C′ 1506. Portions corresponding to the original data (M) 101 included in the corrected erasure correction code C′ 1506 are outputted as the corrected original data (M) 103. For example, as described above, when the encoding of the check codes in the erasure correction code is executed by using Reed-Solomon codes, the falsification location(s) 1232 is used as the location(s) where the erasure(s) has occurred, by assuming the value(s) of the item(s) of the erasure location(s) to be a certain value(s) based on the location(s) where the erasure(s) has occurred, then, an error value(s) is calculated from the certain value(s), and the error value(s) at the erasure location(s) is calculated. In this way, in the erasure correction code including the d check codes, a maximum of d erasures (falsifications) can be corrected by executing erasure correction.

In the retrieved falsified code C′ 1506, if, items, the number of which exceeds the falsification frequency (d) 102, have been falsified, although the falsified portion determination section 1222 can detect the falsification of the stored data, the erasure correction section 1212 cannot execute the erasure correction. Thus, the falsification of the stored data cannot be corrected.

As described above, according to the data storage apparatus 100 according to the second example embodiment of the present invention, it is possible to provide a data storage apparatus that contributes to enabling detection and correction of falsification of stored data and enabling detection of falsification no matter how many stored data have been falsified while keeping the increase amount of the stored data to a minimum, compared with a case in which the original data is encoded by an error correction code (ECC), an error location(s) and an error value(s) are calculated, and error correction is executed.

### Third Example Embodiment

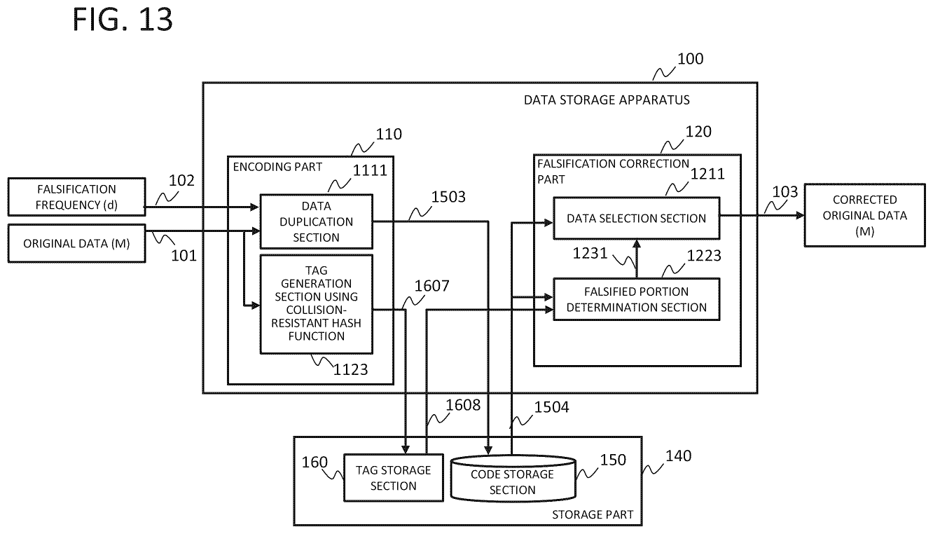

Next, a third example embodiment of the present invention will be described with reference to drawings. FIG. 13 is a diagram illustrating an example of a schematic configuration of a data storage apparatus 100 according to the third example embodiment of the present invention.

In FIG. 13, the same components as those in FIG. 3 illustrating the first example embodiment of the present invention are denoted by the same reference numerals, and the description thereof will be omitted. The third example embodiment of the present invention illustrated in

FIG. 13 is an example embodiment obtained by replacing the MAC tag generation section 1121 in the encoding part 110 in the data storage apparatus 100 according to the first example embodiment of the present invention illustrated in FIG. 3, the MAC tag generation section 1121 corresponding to the tag generation section 112 illustrated in FIG. 1, by a tag generation section 1123 using a collision-resistant hash function.

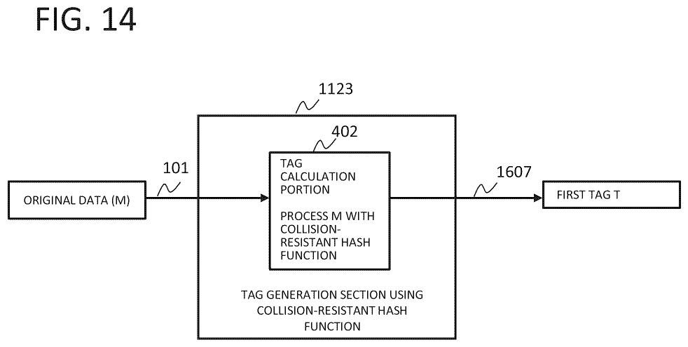

FIG. 14 is a diagram illustrating an example of a schematic operation of the tag generation section 1123 using a collision-resistant hash function, which is included in an encoding part 110 in the data storage apparatus 100 according to the third example embodiment of the present invention. A tag calculation portion 402 in the tag generation section 1123 using a collision-resistant hash function, which is included in the encoding part 110 according to the third example embodiment of the present invention illustrated in FIG. 13, processes (hashes) original data (M) 101 by using the collision-resistant hash function to output as a first tag T 1607. The outputted first tag T 1607 is stored in a tag storage section 160 illustrated in FIG. 13. Note, a code C 1503 outputted from a data duplication section 1111 is stored in a code storage section 150 in a storage part 140 illustrated in FIG. 13. Note, the tag generation using the collision-resistant hash function does not need a shared key (K).

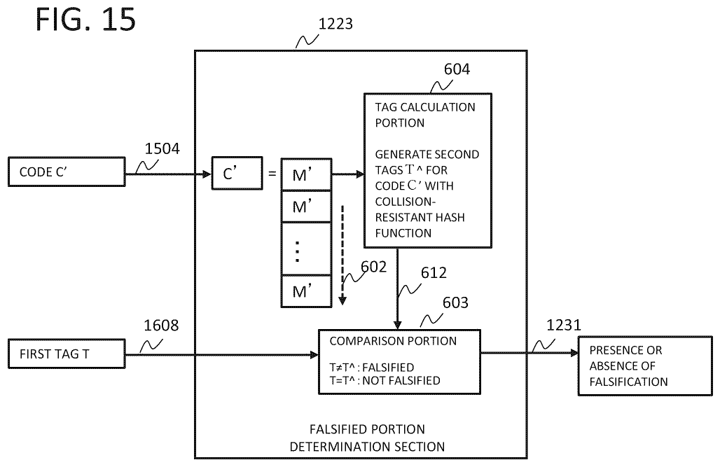

FIG. 15 is a diagram illustrating an example of a schematic operation of a falsified portion determination section 1223 in a falsification correction part 120 in the data storage apparatus 100 according to the third example embodiment of the present invention.

The code storage section 150 in the storage part 140 illustrated in FIG. 13 is a large-capacity off-chip storage section, which may not be secure. The following description assumes that the code stored in the code storage section 150 has been falsified and that a falsified code C′ 1504 is stored in the code storage section 150. In contrast, the tag storage section 160 in the storage part 140 is a secure on-chip storage section, which may not have a large capacity. The following description assumes that the first tag T 1607 stored in the tag storage section 160 has not been falsified. The falsification correction part 120 retrieves the falsified code C′ 1504 from the code storage section 150, and retrieves a first tag T 1608 from the tag storage section 160. The retrieved first tag T 1608 is the same as the stored first tag T 1607.

As illustrated in FIG. 15, the retrieved falsified code C′ 1504 includes data M′, which corresponds to the original data (M) 101 duplicated d+1 times and which could have been falsified. With respect to data M′ included in the falsified code C′ 1504, by using the same method executed by the tag generation section 1123 using the collision-resistant hash function in FIG. 14, a tag calculation portion 604 processes (hashes) the data M′ by using the collision-resistant hash function to sequentially generate second tags T\hat{ } 612 as indicated by an arrow 602. Next, a comparison portion 603 compares the retrieved first tag T 1608 with the second tags T\hat{ } 612. If a second tag T\hat{ } 612 matches the retrieved first tag T 1608, the comparison portion 603 determines that this data M′ has not been falsified. If a second tag T\hat{ } 612 differs from the retrieved first tag T 1608, the comparison portion 603 determines that this data M′ has been falsified. Then, the comparison portion 603 outputs presence or absence of falsification 1231. Note, the operations of the data duplication section 1111 and the data selection section 1211 illustrated in FIG. 13 are the same as those of the data duplication section 1111 and the data selection section 1211 described with reference to FIGS. 4 and 7, and the description thereof will be omitted.

As described above, according to the data storage apparatus 100 according to the third example embodiment of the present invention, it is possible to provide a data storage apparatus that contributes to enabling detection and correction of falsification of stored data and enabling detection of falsification no matter how many stored data have been falsified while keeping the increase amount of the stored data to a minimum, compared with a case in which the original data is encoded by an error correction code (ECC), an error location(s) and an error value(s) are calculated, and error correction is executed.

### Fourth Example Embodiment

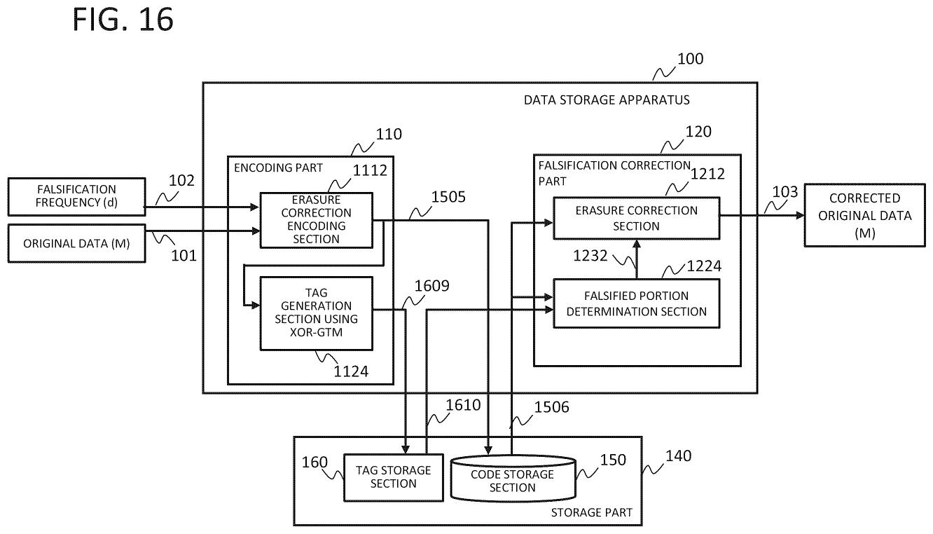

Next, a fourth example embodiment of the present invention will be described with reference to drawings. FIG. 16 is a diagram illustrating an example of a schematic configuration of a data storage apparatus 100 according to the fourth example embodiment of the present invention.

In FIG. 16, the same components as those in FIG. 8 illustrating the second example embodiment of the present invention are denoted by the same reference numerals, and the description thereof will be omitted. The fourth example embodiment of the present invention illustrated in FIG. 16 is an example embodiment obtained by replacing the CDMAC tag generation section 1122 in the encoding part 110 in the data storage apparatus 100 according to the second example embodiment of the present invention illustrated in FIG. 8, which corresponds to the tag generation section 112 illustrated in FIG. 1, by a tag generation section 1124 using exclusive OR Group-Test-based MAC (XOR-GTM), which corresponds to the tag generation section 112 illustrated in FIG. 1.

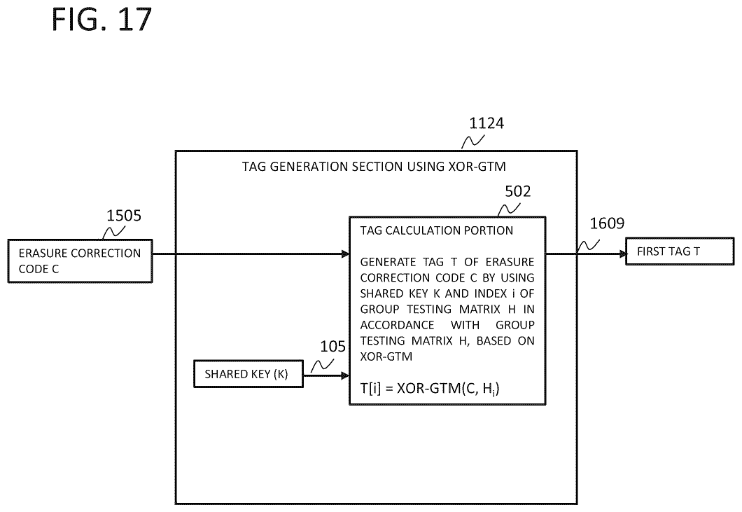

FIG. 17 is a diagram illustrating an example of a schematic operation of the tag generation section 1124 using XOR-GTM included in an encoding part 110 in the data storage apparatus 100 according to the fourth example embodiment of the present invention. A tag calculation portion 502 in the tag generation section 1124 using XOR-GTM generates a tag T of an erasure correction code C by using a shared key K and an index i of a group testing matrix H in accordance with the group testing matrix H, based on XOR-GTM.

For example, as an example of the method executed by the tag generation section using XOR-GTM to generate the tag T, the tag calculation portion 502 extracts all the items corresponding to locations where 1 is set in a row having a row number i in a combinatorial group testing (CGT) matrix H from an erasure correction code C 1505, enters the individual item extracted and its column number j to a pseudorandom function, generates an intermediate tag by adding all the obtained outputs based on exclusive OR, calculates the i-th tag T[i] by encrypting the intermediate tag by executing a Tweakable block cipher using a shared key K in which the row number i in the combinatorial group testing matrix H is used as a Tweak, and generates a first tag T 1609, which is a list of tags T[i] of all the rows in the combinatorial group testing matrix H. The first tag T 1609 is stored in a tag storage section 160 in a storage part 140.

Note, the generation method of the above-described first tag T 1609 may be executed by using the MAC tag list generation apparatus or the MAC tag list generation method disclosed in PTL 4 (WO 2020/213114).

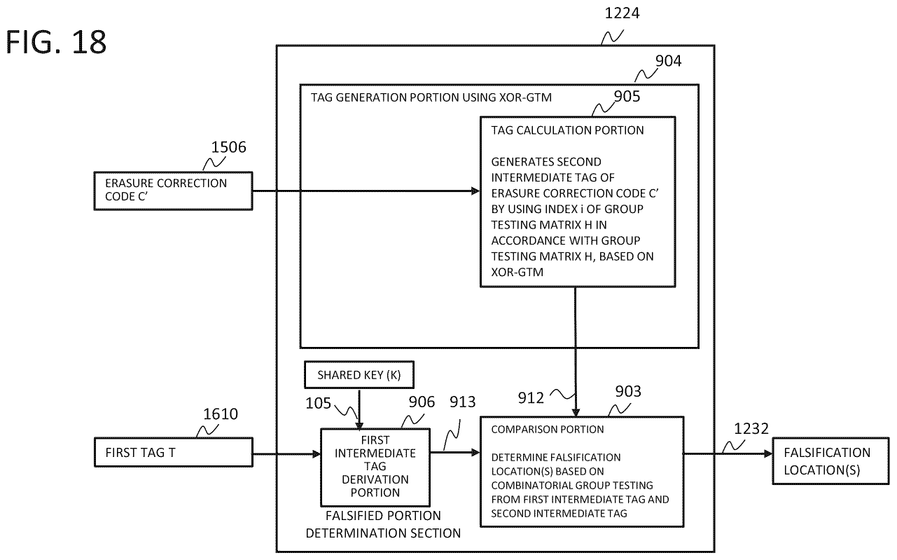

FIG. 18 is a diagram illustrating an example of a schematic operation of a falsified portion determination section 1224 in a falsification correction part 120 in the data storage apparatus 100 according to the fourth example embodiment of the present invention.

A code storage section 150 in the storage part 140 illustrated in FIG. 16 is a large-capacity off-chip storage section, which may not be secure. The following description assumes that the code C 1505 stored in the code storage section 150 has been falsified and that a falsified erasure correction code C′ 1506 is stored in the code storage section 150. In contrast, the tag storage section 160 in the storage part 140 is a secure on-chip storage section, which may not have a large capacity. The following description assumes that the first tag T 1609 stored in the tag storage section 160 has not been falsified. The falsification correction part 120 retrieves the falsified erasure correction code C′ 1506 from the code storage section 150, and retrieves a first tag T 1610 from the tag storage section 160. The retrieved first tag T 1610 is the same as the stored first tag T 1609.

As illustrated in FIG. 18, a tag generation portion 904 using XOR-GTM tag generates a second intermediate tag 912 by using the retrieved falsified erasure correction code C′ 1506 in accordance with the same method executed by the tag generation section 1124 using XOR-GTM in FIG. 17.

That is, a tag calculation portion 905 in the XOR-GTM tag generation portion 904 extracts all the items corresponding to locations where 1 is set in a row having a row number i in a combinatorial group testing (CGT) matrix H from the erasure correction code C′ 1506, enters the individual item extracted and its column number j to a pseudorandom function, generates an intermediate tag by adding all the obtained outputs based on exclusive OR, and generates the second intermediate tag 912, which is a list of intermediate tags of all the rows in the combinatorial group testing matrix H. Meanwhile, a first intermediate tag derivation portion 906 derives a first intermediate tag 913 from the first tag T 1610 by using a shared key 105.

Next, a comparison portion 903 compares the first intermediate tag 913 with the second intermediate tag 912, determines a falsification location(s) in the falsified erasure correction code C′ 1506 based on combinatorial group testing, and outputs a falsification location(s) 1232. The operations of an erasure correction encoding section 1112 and an erasure correction section 1212 illustrated in FIG. 16 are the same as those of the erasure correction encoding section 1112 and the erasure correction section 1212 described with reference to FIGS. 9 and 12.

Note, the example of the schematic operation of the falsified portion determination section 1224 as described above may be executed by using the MAC tag list verification apparatus or the MAC tag list verification method disclosed in PTL 4 (WO 2020/213114).

As described above, according to the data storage apparatus 100 according to the fourth example embodiment of the present invention, it is possible to provide a data storage apparatus that contributes to enabling detection and correction of falsification of stored data and enabling detection of falsification no matter how many stored data have been falsified while keeping the increase amount of the stored data to a minimum, compared with a case in which the original data is encoded by an error correction code (ECC), an error location(s) and an error value(s) are calculated, and error correction is executed.

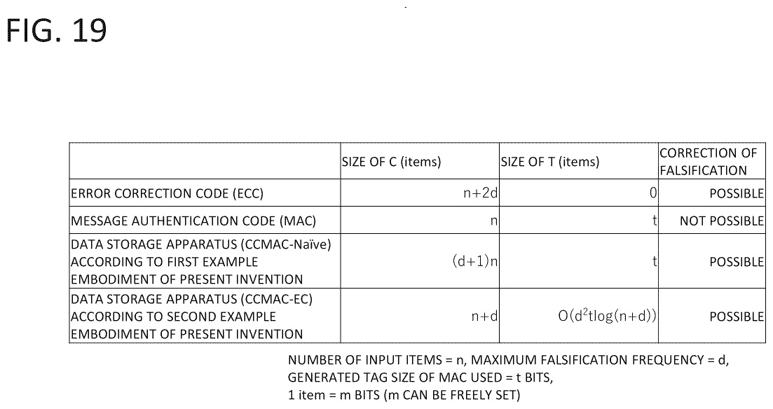

FIG. 19 is a diagram illustrating an example of comparison of parameters among an error correction code (ECC), a message authentication code (MAC), the data storage apparatus (CCMAC-Naive (i is a letter obtained by adding a diaeresis to I)) according to the first example embodiment of the present invention, and the data storage apparatus (CCMAC-EC) according to the second example embodiment of the present invention.

As illustrated in FIG. 19, it is seen that, by the data storage apparatus (CCMAC-Naive (i is a letter obtained by adding a diaeresis to I)) according to the first example embodiment of the present invention and the data storage apparatus (CCMAC-EC) according to the second example embodiment of the present invention, it is possible to provide a data storage apparatus that contributes to enabling detection and correction of falsification of stored data and enabling detection of falsification no matter how many stored data have been falsified while keeping the increase amount of the stored data to a minimum, compared with a case in which the original data is encoded by an error correction code (ECC), an error location(s) and an error value(s) are calculated, and error correction is executed.

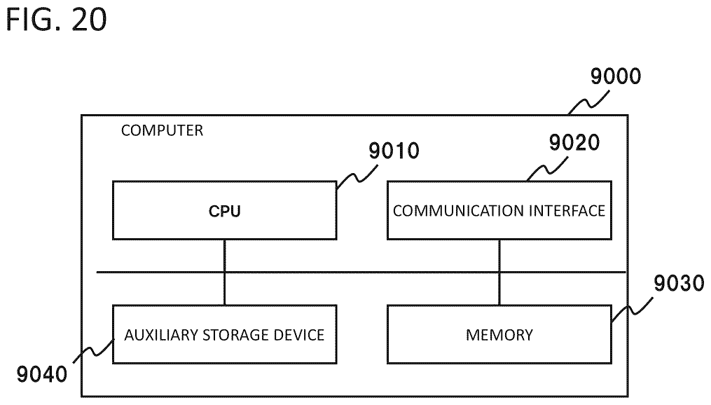

In addition, each of the procedures according to the above-described first to fourth example embodiments can be realized by a program that causes a computer (9000 in FIG. 20) that functions as the corresponding data storage apparatus 100 to realize the functions as the data storage apparatus 100. For example, this computer includes a CPU (Central Processing Unit) 9010, a communication interface 9020, a memory 9030, and an auxiliary storage device 9040 in FIG. 20. That is, the CPU 9010 in FIG. 20 executes a data storage program, and executes processing for updating various calculation parameters stored in the auxiliary storage device 9040, etc.

The memory 9030 is a RAM (Random Access Memory), a ROM (Read-Only Memory), or the like.

That is, an individual element (processing means, function) of the data storage apparatuses according to the above-described first to fourth example embodiments can be realized by a computer program that causes a processor of the above-described computer to execute the corresponding processing described above by using its hardware.

Finally, suitable modes of the present invention will be summarized.

### Mode 1

### (See the Data Storage Apparatus According to the Above-Described First Aspect)

### Mode 2

Regarding the data storage apparatus according to mode 1, it is preferable that
the code generation section generates the code which enables correction of the original data by duplicating the original data based on the falsification frequency;
the tag generation section generates the first tag by processing the original data based on a block cipher using a shared key;
the falsified portion determination section processes individual data, which corresponds to the duplicated original data included in the falsified code, based on the block cipher using the shared key to generate the second tag for each of the individual data, and compares the first tag with each of the second tags to determine falsified data corresponding to the duplicated original data in the falsified code; and
the data correction section outputs the data corresponding to the duplicated original data other than the falsified data in the falsified code, as the corrected original data.

### Mode 3

Regarding the data storage apparatus according to mode 1, it is preferable that
the code generation section generates the code which enables correction of the original data by executing erasure correction coding on the original data based on the falsification frequency;
the tag generation section generates the first tag by using a combinatorial group testing matrix and a message authentication code using a block cipher using a shared key for the code;
the falsified portion determination section generates the second tag by using the combinatorial group testing matrix and the message authentication code using the block cipher using the shared key for the falsified code, and determines the falsified portion(s) in the falsified code by using the first tag and the second tag; and
the data correction section executes erasure correction on the falsified code by using the falsified portion(s) in the falsified code, and outputs data in the code on which the erasure correction has been executed, as the corrected original data.

### Mode 4

Regarding the data storage apparatus according to mode 3, it is preferable that
the message authentication code extracts items corresponding to locations where 1 is set in an i-th row in a combinatorial group testing matrix from the code or the falsified code to concatenate them, calculates a message authentication code tag by using a shared key for each concatenated sequence, executes this procedure for each row in the combinatorial group testing matrix, and generates a first tag or the second tag, which is a list of tags.

### Mode 5

Regarding the data storage apparatus according to mode 1, it is preferable that
the code generation section generates the code which enables correction of the original data by duplicating the original data based on the falsification frequency;
the tag generation section generates the first tag by processing the original data with a collision-resistant hash function;
the falsified portion determination section processes individual data, which corresponds to the duplicated original data included in the falsified code, based on the collision-resistant hash function to generate the second tag for each of the individual data, and compares the first tag with each of the second tags to determine falsified data corresponding to the duplicated original data in the falsified code; and
the data correction section outputs the data corresponding to the duplicated original data other than the falsified data in the falsified code, as the corrected original data.

### Mode 6

Regarding the data storage apparatus according to mode 1, it is preferable that
the code generation section generates the code which enables correction of the original data by executing erasure correction coding on the original data based on the falsification frequency;
the tag generation section generates the first tag by using a combinatorial group testing matrix and an exclusive OR group-test-based message authentication code using a block cipher using a shared key for the code;
the falsified portion determination section generates the second tag by using the combinatorial group testing matrix and the exclusive OR group-test-based message authentication code using the block cipher using the shared key for the falsified code, and determines the falsified portion(s) in the falsified code by using the first tag and the second tag; and
the data correction section executes erasure correction on the falsified code by using the falsified portion(s) in the falsified code, and outputs data in the code on which the erasure correction has been executed, as the corrected original data.

### Mode 7

Regarding the data storage apparatus according to mode 6, it is preferable that
the exclusive OR group-test-based message authentication code extracts all items corresponding to locations where 1 is set in a row having a row number i in the combinatorial group testing matrix from the code or the falsified code, enters the individual item extracted and a column number j to a pseudorandom function, generates an intermediate tag by adding all obtained outputs based on exclusive OR, calculates an i-th tag by encrypting the intermediate tag by executing a Tweakable block cipher in which the row number i in the combinatorial group testing matrix is used as a Tweak and in which the shared key is used, and generates a first tag or the second tag, which is a list of the tags of all the rows in the combinatorial group testing matrix.

### Mode 8

Regarding the data storage apparatus according to any one of modes 3, 4, 6, and 7, it is preferable that the code generation section executes the erasure correction coding on the original data by using a Reed-Solomon code.

### Mode 9

### (See the Data Storage Method According to the Above-Described Second Aspect)

### Mode 10

(See the Program according to the Above-Described Third Aspect)

Note, modes 9 and 10 described above can be expanded in the same way as mode 1 is expanded to modes 2 to 8.

Note, the disclosure of each of the above PTLs is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

100 data storage apparatus
101 original data (M)
102 falsification frequency (d)
103 corrected original data (M)
110 encoding part
111 code generation section
112 tag generation section
120 falsification correction part
121 data correction section
122 falsified portion determination section
140 storage part
150 code storage section
160 tag storage section
1111 data duplication section
1121 MAC tag generation section
1211 data selection section
1221 falsified portion determination section
1112 erasure correction encoding section
1122 CDMAC tag generation section
1212 erasure correction section
1222 falsified portion determination section
1123 tag generation section using collision-resistant hash function
1223 falsified portion determination section
1124 tag generation section using exclusive OR Group-Test-based Message authentication code (XOR-GTM)
1224 falsified portion determination section
9000 computer
9010 CPU
9020 communication interface
9030 memory
9040 auxiliary storage device

What is claimed is:

1. A data storage apparatus, comprising:
at least a processor; and
a memory in circuit communication with the processor,
wherein the processor is configured to execute program instructions stored in the memory to perform:
generating, based on original data and a falsification frequency, a code which enables correction of the original data;
generating a first tag which enables detection of falsification of the original data, based on the original data;
storing the code and the first tag in a storage part;
retrieving a falsified code and the first tag from the storage part;
generating a second tag based on the falsified code, and determining a falsified portion(s) in the falsified code by using the first tag and the second tag; and
outputting corrected original data by using the determined falsified portion(s) and the falsified code.

2. The data storage apparatus according to claim 1,
wherein the generating the code comprises generating the code which enables correction of the original data by duplicating the original data based on the falsification frequency;
wherein the generating the first tag comprises generating the first tag by processing the original data based on a block cipher using a shared key;
wherein the generating the second tag and the determining comprises processing individual data, which corresponds to the duplicated original data included in the falsified code, based on the block cipher using the shared key to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

3. The data storage apparatus according to claim 1,
wherein the generating the code comprises generating the code which enables correction of the original data by executing erasure correction coding on the original data based on the falsification frequency;
wherein the generating the first tag comprises generating the first tag by using a combinatorial group testing matrix and a message authentication code using a block cipher using a shared key for the code;
wherein the generating the second tag and the determining comprises generating the second tag by using the combinatorial group testing matrix and the message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.

4. The data storage apparatus according to claim 3;
wherein the message authentication code extracts items corresponding to locations where 1 is set in an i-th row in a combinatorial group testing matrix from the code or the falsified code to concatenate them, calculates a message authentication code tag by using a shared key for each concatenated sequence, executes this procedure for each row in the combinatorial group testing matrix, and generates a first tag or the second tag, which is a list of tags.

5. The data storage apparatus according to claim 1,
wherein the generating the code comprises generating the code which enables correction of the original data by duplicating the original data based on the falsification frequency;
wherein the generating the first tag comprises generating the first tag by processing the original data with a collision-resistant hash function;
wherein the generating the second tag and the determining comprises processing individual data, which corresponds to the duplicated original data included in the falsified code, based on the collision-resistant hash function to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

6. The data storage apparatus according to claim 1,
wherein the generating the code comprises generating the code which enables correction of the original data by executing erasure correction coding on the original data based on the falsification frequency;
wherein the generating the first tag comprises generating the first tag by using a combinatorial group testing matrix and an exclusive OR group-test-based message authentication code using a block cipher using a shared key for the code;
wherein the generating the second tag and the determining comprises generating the second tag by using the combinatorial group testing matrix and the exclusive OR group-test-based message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.

7. The data storage apparatus according to claim 6,
wherein the exclusive OR group-test-based message authentication code extracts all items corresponding to locations where 1 is set in a row having a row number i in the combinatorial group testing matrix from the code or the falsified code, enters the individual item extracted and a column number j to a pseudorandom function, generates an intermediate tag by adding all obtained outputs based on exclusive OR, calculates an i-th tag by encrypting the intermediate tag by executing a Tweakable block cipher in which the row number i in the combinatorial group testing matrix is used as a Tweak and in which the shared key is used, and generates a first tag or the second tag, which is a list of the tags of all the rows in the combinatorial group testing matrix.

8. The data storage apparatus according to claim 3, wherein the generating the code comprises executing the erasure correction coding on the original data by using a Reed-Solomon code.

9. A data storage method, executed by a computer and comprising:
generating, based on original data and a falsification frequency, a code which enables correction of the original data;
generating a first tag which enables detection of falsification of the original data, based on the original data;
storing the code and the first tag in a storage part;
retrieving a falsified code and the first tag from the storage part;
generating a second tag based on the falsified code and determining a falsified portion(s) in the falsified code by using the first tag and the second tag; and
outputting corrected original data by using the determined falsified portion(s) and the falsified code.

10. A computer-readable non-transitory recording medium recording a program, the program, which causes a computer to perform processings of:
generating, based on original data and a falsification frequency, a code which enables correction of the original data;
generating a first tag which enables detection of falsification of the original data, based on the original data;
storing the code and the first tag in a storage part;
retrieving a falsified code and the first tag from the storage part;
generating a second tag based on the falsified code and determining a falsified portion(s) in the falsified code by using the first tag and the second tag; and
outputting corrected original data by using the determined falsified portion(s) and the falsified code.

11. The data storage method according to claim 9,
wherein the generating the code comprises generating the code which enables correction of the original data by duplicating the original data based on the falsification frequency;
wherein the generating the first tag comprises generating the first tag by processing the original data based on a block cipher using a shared key;
wherein the generating the second tag and the determining comprises processing individual data, which corresponds to the duplicated original data included in the falsified code, based on the block cipher using the shared key to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

12. The data storage method according to claim 9,
wherein the generating the code comprises generating the code which enables correction of the original data by executing erasure correction coding on the original data based on the falsification frequency;
wherein the generating the first tag comprises generating the first tag by using a combinatorial group testing matrix and a message authentication code using a block cipher using a shared key for the code;
wherein the generating the second tag and the determining comprises generating the second tag by using the combinatorial group testing matrix and the message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.

13. The data storage method according to claim 12;
wherein the message authentication code extracts items corresponding to locations where 1 is set in an i-th row in a combinatorial group testing matrix from the code or the falsified code to concatenate them, calculates a message authentication code tag by using a shared key for each concatenated sequence, executes this procedure for each row in the combinatorial group testing matrix, and generates a first tag or the second tag, which is a list of tags.

14. The data storage method according to claim 9,
wherein the generating the code comprises generating the code which enables correction of the original data by duplicating the original data based on the falsification frequency;
wherein the generating the first tag comprises generating the first tag by processing the original data with a collision-resistant hash function;
wherein the generating the second tag and the determining comprises processing individual data, which corresponds to the duplicated original data included in the falsified code, based on the collision-resistant hash function to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

15. The data storage method according to claim 9,
wherein the generating the code comprises generating the code which enables correction of the original data by executing erasure correction coding on the original data based on the falsification frequency;
wherein the generating the first tag comprises generating the first tag by using a combinatorial group testing matrix and an exclusive OR group-test-based message authentication code using a block cipher using a shared key for the code;
wherein the generating the second tag and the determining comprises generating the second tag by using the combinatorial group testing matrix and the exclusive OR group-test-based message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.

16. The medium according to claim 10,
wherein the generating the code comprises generating the code which enables correction of the original data by duplicating the original data based on the falsification frequency;
wherein the generating the first tag comprises generating the first tag by processing the original data based on a block cipher using a shared key;
wherein the generating the second tag and the determining comprises processing individual data, which corresponds to the duplicated original data included in the falsified code, based on the block cipher using the shared key to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

17. The medium according to claim 10,
wherein the generating the code comprises generating the code which enables correction of the original data by executing erasure correction coding on the original data based on the falsification frequency;
wherein the generating the first tag comprises generating the first tag by using a combinatorial group testing matrix and a message authentication code using a block cipher using a shared key for the code;
wherein the generating the second tag and the determining comprises generating the second tag by using the combinatorial group testing matrix and the message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.

18. The medium according to claim 17;
wherein the message authentication code extracts items corresponding to locations where 1 is set in an i-th row in a combinatorial group testing matrix from the code or the falsified code to concatenate them, calculates a message authentication code tag by using a shared key for each concatenated sequence, executes this procedure for each row in the combinatorial group testing matrix, and generates a first tag or the second tag, which is a list of tags.

19. The medium according to claim 10,
wherein the generating the code comprises generating the code which enables correction of the original data by duplicating the original data based on the falsification frequency;
wherein the generating the first tag comprises generating the first tag by processing the original data with a collision-resistant hash function;
wherein the generating the second tag and the determining comprises processing individual data, which corresponds to the duplicated original data included in the falsified code, based on the collision-resistant hash function to generate the second tag for each of the individual data, and comparing the first tag with each of the second tags to determine falsified data corresponding to the duplicated original data in the falsified code; and
wherein the outputting comprises outputting the data corresponding to the duplicated original data other than the falsified data in the falsified code, as the corrected original data.

20. The medium according to claim 10,
wherein the generating the code comprises generating the code which enables correction of the original data by executing erasure correction coding on the original data based on the falsification frequency;
wherein the generating the first tag comprises generating the first tag by using a combinatorial group testing matrix and an exclusive OR group-test-based message authentication code using a block cipher using a shared key for the code;
wherein the generating the second tag and the determining comprises generating the second tag by using the combinatorial group testing matrix and the exclusive OR group-test-based message authentication code using the block cipher using the shared key for the falsified code, and determining the falsified portion(s) in the falsified code by using the first tag and the second tag; and
wherein the outputting comprises executing erasure correction on the falsified code by using the falsified portion(s) in the falsified code, and outputting data in the code on which the erasure correction has been executed, as the corrected original data.
